(19) United States
(12) Patent Application Publication
(10) Pub. No.: US 2019/0211646 A1
(43) Pub. Date: Jul. 11, 2019

(54) SLIP RING SEGMENT FOR DOWNHOLE TOOL

(71) Applicants: Eric Gregory, Larkspur, CA (US); Marco Zvanik, San Francisco, CA (US); Jonathan Worthy Hollander, San Francisco, CA (US)

(72) Inventors: Eric Gregory, Larkspur, CA (US); Marco Zvanik, San Francisco, CA (US); Jonathan Worthy Hollander, San Francisco, CA (US)

(73) Assignee: Seriforge, Inc., San Francisco, CA (US)

(21) Appl. No.: 15/864,998

(22) Filed: Jan. 8, 2018

(51) Int. Cl. E21B 33/129; E21B 33/12; B32B 1/00; B32B 5/06; B32B 17/00; B32B 9/00; B32B 9/04; B32B 17/06

(52) U.S. Cl. CPC E21B 33/129; E21B 33/1204; B32B 1/00; B32B 5/06; E21B 33/1243; B32B 9/007; B32B 9/04; B32B 17/067; B32B 17/00

(57) ABSTRACT

A slip ring segment, used as a part of a downhole tool placeable within a well casing, includes a stack of fabric layers, the fabric layers comprising fibers, such as carbon fiber and glass fiber, the stack having first and second surfaces, which can be axially tapering surfaces, and stitching passing through the stack. The stitching can conform to ASTM D6193, 205 hand stitching. The stitching includes first stitching portions passing through the stack, and second stitching portions connecting selected first stitching portions and extending along the first and second surfaces without knots, crimps or loops, with the first and second surfaces and the fabric layers substantially un-deformed by the stitching. The slip ring segment also includes a matrix binding the stack of fabric layers and the stitching, and well casing-engaging elements extending from the interior of the stack out past first surface.

### CROSS-REFERENCE TO OTHER APPLICATIONS

This application uses technology disclosed in U.S. Pat. No. 9,381,702 issued 5 Jul. 2016, the disclosure of which is incorporated by reference.

### FEDERALLY SPONSORED RESEARCH OR DEVELOPMENT

None.

### BACKGROUND OF THE INVENTION

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves may also correspond to implementations of the claimed technology.

It is often desired to isolate certain sections of well casing lining a wellbore, the well being used to extract, for example, natural gas or oil. Isolation plugs can be positioned at suitable locations within the well casing, such as by a drill string, and secured in place.

One type of isolation plug is a fracking/bridge plug typically having a pair of segmented slip rings on either side of an expandable seal. The slip rings can be expanded to securely engage the well casing by, for example, the movement of slip rings spreaders located between the expandable seal and the slip ring. The slip rings can have pins, teeth, fins or other projections extending from the outer surface of the slip rings to firmly engage the well casing to prevent the movement of the plug. The slip rings are typically made of materials, such as cast-iron, or carbon fiber, or glass reinforced plastics, which can be milled and drilled when they need to be removed.

### BRIEF SUMMARY OF THE INVENTION

A simplified summary is provided herein to help enable a basic or general understanding of various aspects of exemplary, non-limiting implementations that follow in the more detailed description and the accompanying drawings. This summary is not intended, however, as an extensive or exhaustive overview. Instead, the sole purpose of this summary is to present some concepts related to some exemplary non-limiting implementations in a simplified form as a prelude to the more detailed description of the various implementations that follow.

A slip ring is used as a part of a downhole tool placeable within a well casing. The slip ring is comprised of multiple slip ring segments. The slip ring segment includes a stack of fabric layers, the fabric layers comprising fibers, the stack having first and second surfaces, and stitching passing through the stack. The stitching includes first stitching portions passing through the stack, and second stitching portions connecting selected first stitching portions and extending along the first and second surfaces. The slip ring segment also includes a matrix binding the stack of fabric layers and the stitching, and optionally well casing-engaging elements extending from the first surface.

The slip ring segment can include one or more the following. The fabric layers can include one or more of carbon fiber and glass fiber. The second stitching portions can include substantially straight segments without knots, crimps or loops. The stitching can conform to ASTM D6193, 205 hand stitching. The first and second surfaces and the fabric layers can be substantially un-deformed by the stitching. The first and second surfaces can be curved surfaces substantially co-radial to one another. The first stitching portions can be substantially parallel to one another. The first stitching portions can be radially extending stitching portions. At least a portion of the second surface can be at an angle to the first surface. The well casing-engaging elements can extend to positions between the first and second surfaces. At least one of the first and second surfaces can include an axially tapered portion; the axially tapered portion can be formed from the fabric layers prior to resin encapsulation.

Other features, aspects and advantages of technology disclosed can be seen on review the drawings, the detailed description, and the claims, which follow.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 is a somewhat simplified side view of a composite fracking/bridge plug including slip rings, the slip rings made of slip ring segments according to the technology disclosed.

FIG. 2 is a simplified exploded isometric view illustrating fabric layers to be placed in a form to create a stack of fabric layers having an appropriate shape.

FIG. 3 illustrates a stack of fabric layers after stitching to create a stitched stack of fabric layers.

FIG. 4 is a simplified cross-sectional view taken along line 4-4 of FIG. 3 illustrating first stitching portions extending through the stitched stack of fabric layers and second stitching portions along the first, upper surface and the second, lower surface of the stitched stack of fabric layers, the stitching shown in broken lines for ease of illustration.

FIG. 5 illustrates the stitched stack of fabric layers of FIG. 3 after pins have been inserted through the first, outer surface and into the interior of the stitched stack of fabric layers, and after a matrix material has been applied to the stitched stack of fabric layers to create a slip ring segment.

FIG. 6 is a simplified cross-sectional view showing one of the pins of FIG. 5 extending partway through the stitched stack of fabric layers of the slip ring segment.

FIG. 7 is a simplified cross-sectional view of a first alternative embodiment in which the second stitching portions extend circumferentially over the first, outer surface of the stitched stack of fabric layers and the first stitching portions extend radially therethrough.

FIG. 8 is a simplified cross-sectional view of a second alternative embodiment in which the second stitching portions extend circumferentially over the first, outer surface of the stitched stack of fabric layers and the first stitching portions extend generally parallel to one another, through the stitched stack of fabric layers.

### DETAILED DESCRIPTION

The following description will typically be with reference to specific structural embodiments and methods. It is to be understood that there is no intention to-be limited to the specifically disclosed embodiments and methods but that other features, elements, methods and embodiments may be used for implementations of this disclosure. Preferred embodiments are described to illustrate the technology disclosed, not to limit its scope, which is defined by the claims. Those of ordinary skill in the art will recognize a variety of equivalent variations on the description that follows. Unless otherwise stated, in this application specified relationships, such as parallel to or substantially parallel to, perpendicular to or substantially perpendicular to, straight or substantially straight, un-deformed or substantially un-deformed, aligned with, or in the same plane as, mean that the specified relationships are within limitations of manufacturing processes and within manufacturing variations. When components are described as being coupled, connected, being in contact or contacting one another, they need not be physically directly touching one another unless specifically described as such. Like elements in various embodiments are commonly referred to with like reference numerals.

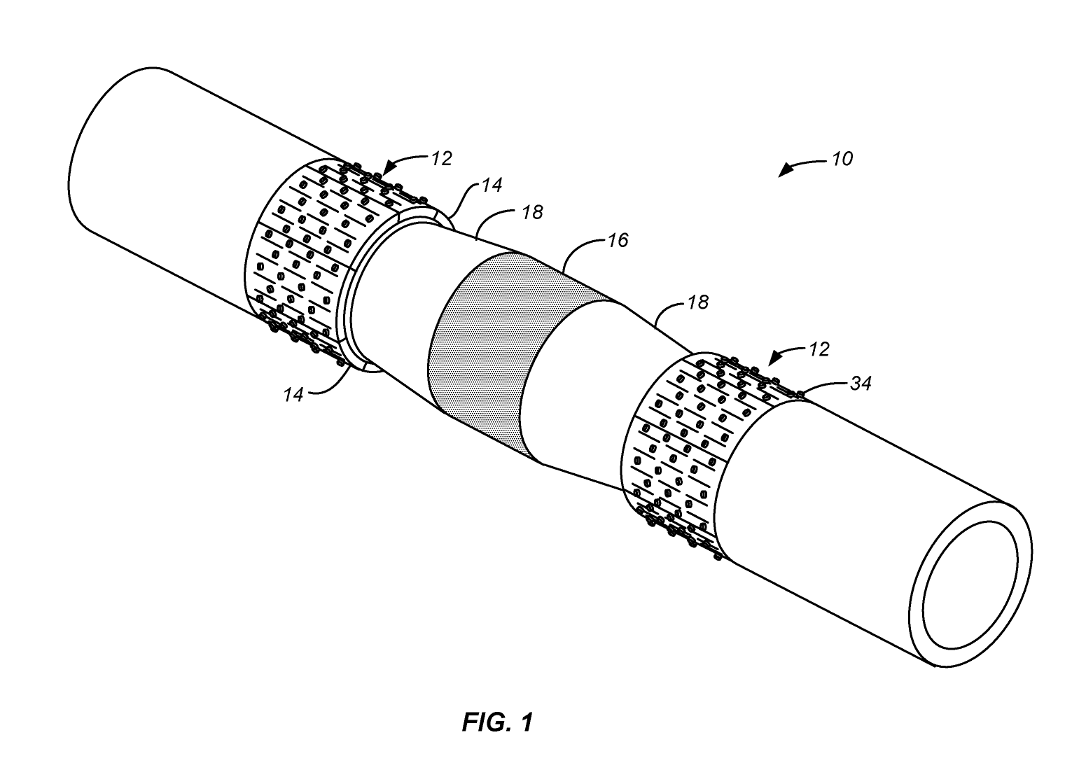

FIG. 1 is a somewhat simplified side view of a composite fracking/bridge plug 10 including slip rings 12 made of well casing-engaging elements, referred to as slip ring segments 14, according to the technology disclosed. With the exception of slip rings 12 and slip ring segments 14, plug 10 can be conventional. Plug 10, in this example, includes expandable seal 16 and a slip ring spreader 18 on either side of the expandable seal. The slip rings spreaders 18 are used to expand the slip ring segments 14 outwardly against the wall of the well casing, the well casing not illustrated. The slip ring segments have outwardly extending pins or other protrusions to help secure the slip rings in place against the well casing. The technology discussed will typically be in terms of use with a fracking/bridge plug. However, the current technology can also be used with other downhole tools used within well casings.

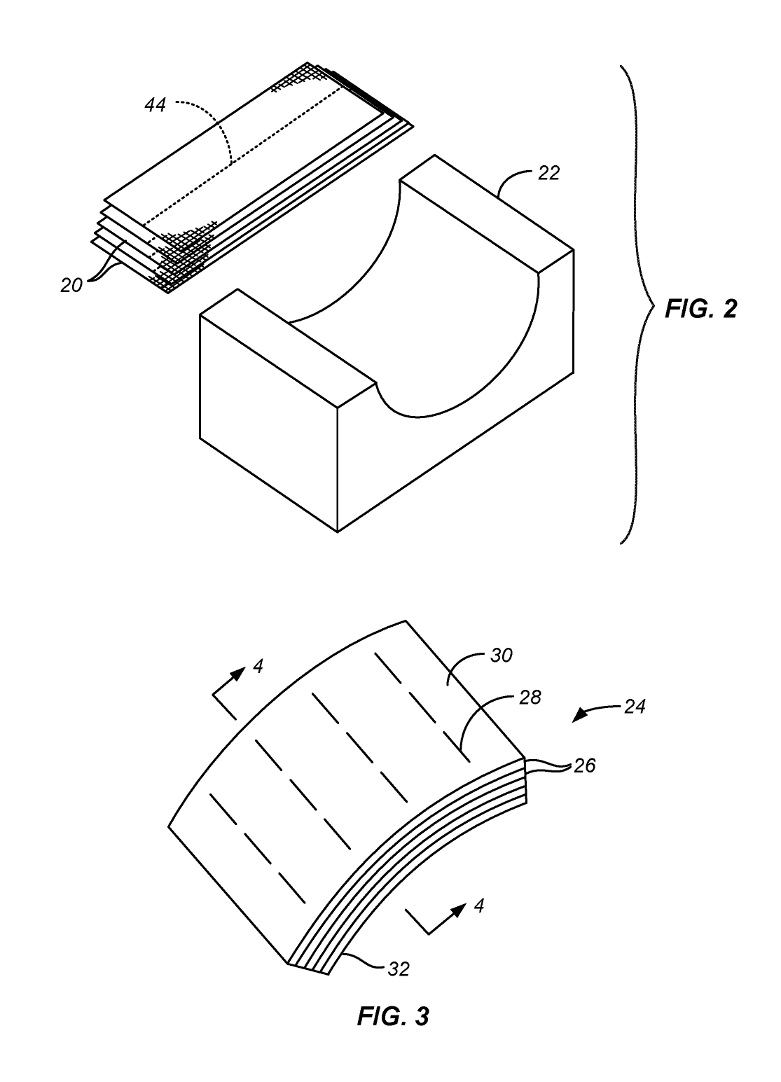

FIG. 2 is a simplified exploded isometric view illustrating a number of fabric or other fibrous layers 20 shown to be placed in a form 22 to create a shaped stack of fabric layers having an appropriate shape. As used herein, fabric layers include woven fabric layers and unidirectional, biaxial, or multiaxial non-woven fabric layers, but also include, for example, veils and other felted or other nonwoven fabric layers, knitted fabric layers, scrim fabric layers, and netting fabric layers, and loose fiber yarns or tows, or combinations thereof. In some examples primarily uni-axial and biaxial fabric layers, with some woven fabric layers, are used. To accommodate the curved form of the resulting shaped stack of fabric layers, the lengths of the individual layers can be varied to accommodate the resulting circumferential lengths of each of the fabric layers in the curved stack of fabric layers. This difference in length is shown in an exaggerated form in FIG. 2. Instead of varying the length of the individual fabric layers, the shaped stack of fabric layers, not separately illustrated, after being formed, can be trimmed in an appropriate manner. This trimming can be either before or after subsequent stitching or matrix encapsulating processing steps, discussed below.

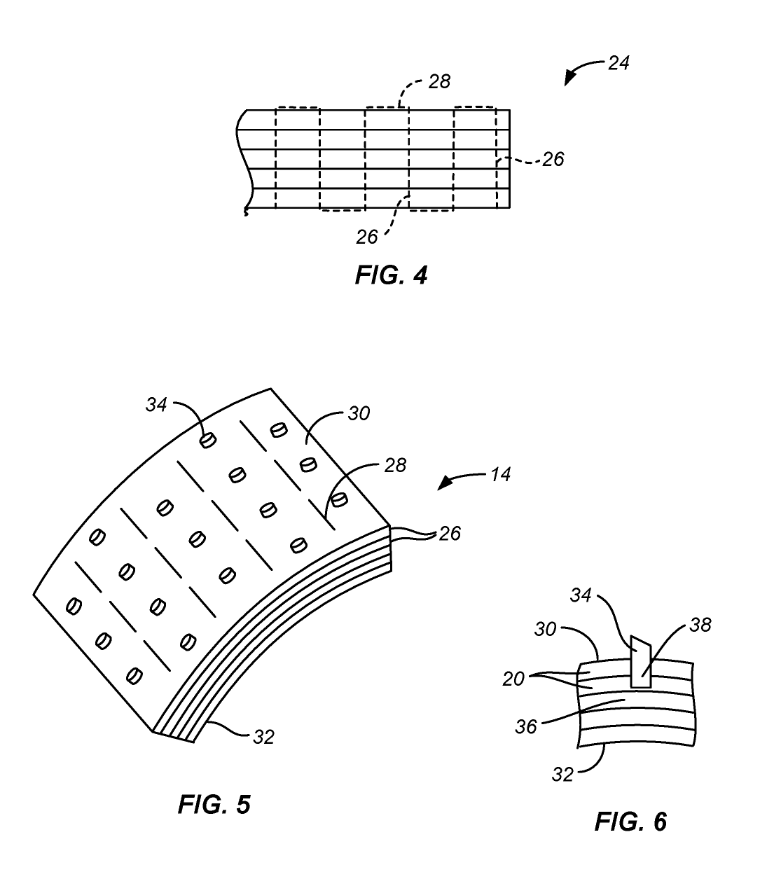

FIG. 3 illustrates the shaped stack of fabric layers after stitching to create a stitched stack of fabric layers 24. Stitching can be carried out using the techniques disclosed in U.S. Pat. No. 9,381,702. FIG. 4 is a simplified cross-sectional view taken along line 4-4 of FIG. 3 illustrating first stitching portions 26 extending through the stitched stack of fabric layers 24 and 28 second stitching portions along the first, upper surface 30 and the second, lower surface 32 of the stitched stack of fabric layers 24. First and second stitching portions 26, 28 are preferably oriented generally perpendicular to one another.

In this example first, upper surface 30 and second, lower surface 32 are curved, generally co-radial surfaces, that is having generally the same center of curvature, with first stitching portions 26 being straight segments without knots, crimps or loops. First stitching portions 26 extend radially with respect to the first and second curved surfaces 30, 32. The first stitching portions 26 can deviate from a purely straight, radial character typically as a result of small deflections of the needle used during the stitching operation. Accordingly, the first stitching portions 26 can be considered to be substantially straight with a substantially radial orientation within the limitations of manufacturing processes and within manufacturing variations.

The second stitching portions 28 joining adjacent first stitching portions 26 are created so they are parallel to the first, upper surface 30 and the second, lower surface 32. At least a majority of second stitching portions 28 are substantially perpendicular to first stitching portions 26. The stitching preferably conforms to ASTM D6193, 205 hand stitching pattern. The stitching can be carried out in the manners discussed in U.S. Pat. No. 9,381,702. By creating the stitching in the manner disclosed in this patent, the upper and lower surfaces 30, 32 can be substantially un-deformed so that in terms of fabric deformation, the upper and lower surfaces 30, 32, as well as the intervening fabric layers, are not substantially crimped by the stitching. This ensures that the fibers comprising the fabric layers are not distorted or displaced from their alignment with the respective surfaces.

Stitched stack of fabric layers 24 is encapsulated with a matrix, which binds the layers 20 and pins 34, which when cured creates slip ring segments 14 of FIGS. 1 and 5. The insertion of pins 34 is discussed below. Resin encapsulation may be performed by inserting the dry fabric layers into a closed mold and using vacuum and/or high pressure to infuse resin into the fabric. If needed the cured structure can be trimmed to the desired dimensions and configuration for slip ring segment 14. The matrix can include, for example, a thermoset or thermoplastic polymer matrix, such as epoxy, polyurethane, vinyl ester, phenolic, nylon, PEEK, a ceramic matrix, such as silicon carbide, or a combination of matrices.

FIG. 5 illustrates the stitched stack of fabric layers 24 of FIG. 3 after the inner ends 38 of pins 34 have been inserted through the first, outer surface 30 and into the interior 36 of the stitched stack of fabric layers 24 to create a pinned structure 40. The rigid, cured stitched stack of fabric layers 24 is machined or drilled to make receptacles for the pins 34, and then the pins are inserted and bonded in place with epoxy or other adhesive. The positions of the inner ends 38 between fabric layers 20 is illustrated in FIG. 6. In some examples pins 34 may be inserted at an angle into the stitched stack of fabric layers 24 instead of or in addition to the use of a beveled tip. In some examples, pins may be inserted before curing the matrix. Fabric layers 20 are typically made of non-crimp unidirectional and multiaxial fabrics and woven fabrics. The fibers of the different fabric layers 20 may be oriented at different angles with respect to each other and/or include fabric layers with random oriented fibers according to the structural characteristics desired of the finished part. The fibers used to create fabric layers 20 can be carbon fibers to create carbon fiber layers or sheets for enhanced strength. Fabric layers 20 can also be made of, for example, glass fibers to create glass fiber layers or sheets. Other types of fibers, including polymer fibers, can also be used. In some examples a combination of two or more different types of fibers can be used. Carbon fiber can be used for the stitching, especially when enhanced strength is desired. In some situations other types of stitching fiber materials, such as polyester fibers, or a combination of different stitching materials, can be used.

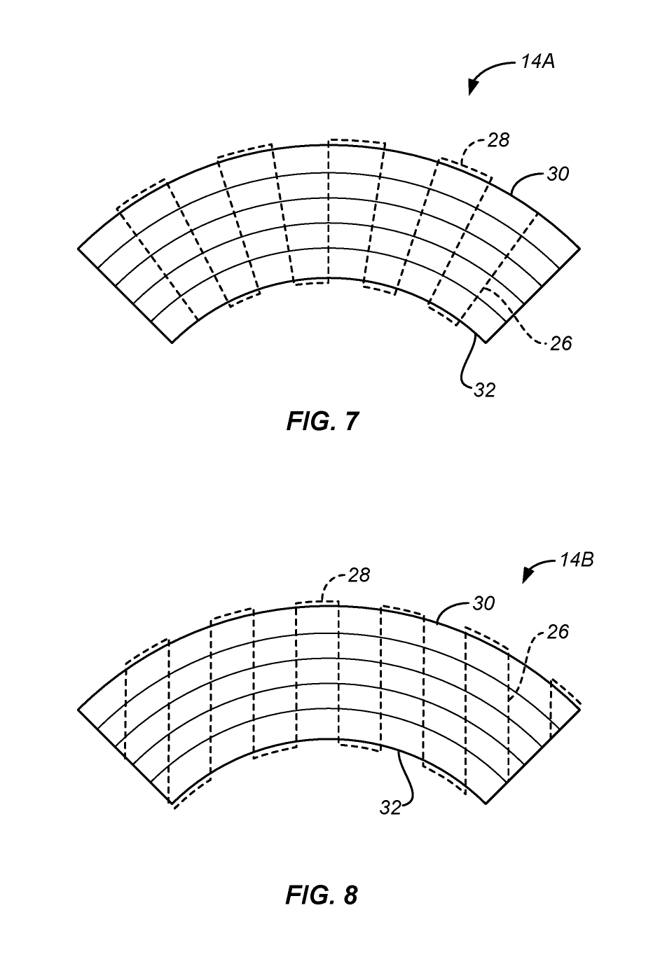

FIG. 7 is a simplified cross-sectional view of a first alternative embodiment of a slip ring segment 14A in which the second stitching portions 28 extend circumferentially over the first, outer surface 30 and the second, lower surface 32 of the stack of fabric layers 20. In this example the first stitching portions 26 extend radially through the stack of fabric layers 20.

FIG. 8 is a simplified cross-sectional view of a second alternative embodiment of a slip ring segment 14B in which the second stitching portions 28 extend circumferentially over the first, outer surface 30 and the second, lower surface 32 of the stack of fabric layers 20. In this example the first stitching portions 26 extend a parallel to one another through the stack of fabric layers. This parallel orientation of first stitching portions 26 could also be used with the example of FIGS. 1-6.

The current technology provides for slip ring segments which can be drillable and millable to permit them to be removed from the well casing when no longer needed. Use of matrix encapsulated fabric layers provides for an extremely strong slip ring segment. The stitching effectively prevents separation of fabric layers 20 by the inner ends 38 of pins 34 when the slip ring segments are driven against the well casing with sufficient force to drive pins 34 into the well casing. When sections of the well are pressurized, the slip rings experience a high interlaminar shear load, often in excess of hundreds of thousands of pounds. Without the presence of the stitching, this interlaminar shear load would be carried primarily by the matrix material between fabric layers, which is substantially weaker than the fabric layers. With stitching, the stitching fibers distribute the shear forces throughout the fabric layers, substantially increasing the shear loading capacity of the slip ring segments.

In some examples the fabric layers 20 at the first, outer surface 30 could be made long enough so it acts as the outermost fabric layer 20 for a series of slip ring segments 14 created using a row of closely spaced forms 22. Such a construction could be useful in mounting the slip ring segments 14 to the remainder of the plug 10.

In some examples it may be desired to have the second, inner surface 32 of the slip ring segments 14 taper axially relative to the first, outer surface 30 to accommodate the structure used to force the split rings against the well casing. This can be done at various times during the manufacture, including trimming the fabric layers 20 so they decrease in both length and width as suggested by the broken lines 44 in FIG. 2 and/or by bending or folding fabric layers to conform to a tapered portion of the form. By doing so at least a portion of the second, inner surface 32 would be at an angle to the first, outer surface 30. Having at least a portion of the second, inner surface 32 be at an angle to the first, outer surface 30 creates a ramped or sloped section on the inner surface which can mate with, for example, a conical slip ring spreader.

The above descriptions may have used terms such as above, below, top, bottom, over, under, et cetera. These terms may be used in the description and claims to aid understanding what is being disclosed and not used in a limiting sense.

While implementations of the technology are disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the technology disclosed and the scope of the following claims.

Any and all patents, patent applications and printed publications referred to above are incorporated by reference.

What is claimed is:

1. A slip ring segment for use as a part of a downhole tool placeable within a well casing, comprising:
a stack of fabric layers, the fabric layers comprising fibers, the stack having first and second surfaces;
stitching passing through the stack, the stitching comprising:
first stitching portions passing through the stack;
second stitching portions connecting selected first stitching portions and extending along the first and second surfaces; and
a matrix binding the stack of fabric layers and the stitching; and
well casing-engaging elements extending from the first surface.

2. The slip ring segment according to claim 1, wherein the fabric layers comprise carbon fiber.

3. The slip ring segment according to claim 1, wherein the fabric layers comprise glass fiber.

4. The slip ring segment according to claim 1, wherein the second stitching portions comprise substantially straight segments without knots, crimps or loops.

5. The slip ring segment according to claim 1, wherein the stitching conforms to ASTM D6193, 205 hand stitching.

6. The slip ring segment according to claim 1, wherein least a majority of the second stitching portions extend substantially perpendicular to the first stitching portions.

7. The slip ring segment according to claim 1, wherein the first and second surfaces are substantially un-deformed by the stitching.

8. The slip ring segment according to claim 7, wherein the fabric layers are substantially un-deformed by the stitching.

9. The slip ring segment according to claim 1, wherein the first and second surfaces are curved surfaces substantially co-radial to one another.

10. The slip ring segment according to claim 9, wherein the first stitching portions are substantially parallel to one another.

11. The slip ring segment according to claim 9, wherein the first stitching portions are radially extending stitching portions.

12. The slip ring segment according to claim 1, wherein at least a portion of the second surface is at an angle to the first surface.

13. The slip ring segment according to claim 1, wherein the matrix comprises at least one of a polymer matrix and a ceramic matrix.

14. The slip ring segment according to claim 1, wherein the well casing-engaging elements extend to positions between the first and second surfaces.

15. The slip ring segment according to claim 1, wherein at least one of the first and second surfaces includes an axially tapered portion.

16. The slip ring segment according to claim 15, wherein the axially tapered portion is formed from the fabric layers prior to resin encapsulation.

17. A slip ring segment for use as a part of a downhole tool placeable within a well casing, comprising:
a stack of fabric layers, the fabric layers comprising carbon fibers, the stack having first and second surfaces;
carbon fiber stitching, conforming to ASTM D6193, 205 hand stitching, passing through the stack, the stitching comprising:
first stitching portions passing through the stack;
second stitching portions connecting selected first stitching portions and extending along the first and second surfaces, the second stitching portions comprising substantially straight segments without knots, crimps or loops; and
the first and second surfaces are being substantially un-deformed by the stitching;
a matrix binding the stack of fabric layers and the stitching; and
well casing-engaging elements extending from the first surface extending to positions between the first and second surfaces.
